(19) United States
(12) Patent Application Publication
(10) Pub. No.: US 2014/0237063 A1
(43) Pub. Date: Aug. 21, 2014

(54) SYSTEM AND METHOD FOR TRANSMITTING AND RECEIVING PEER-TO-PEER MESSAGES USING A MEDIA KEY, AND MANAGING THE MEDIA KEY

(71) Applicant: Hee Tae Yoon, Seoul (KR)

(72) Inventor: Hee Tae Yoon, Seoul (KR)

(73) Assignee: SAMSUNG SDS CO., LTD., Seoul (KR)

(21) Appl. No.: 14/347,577

(22) PCT Filed: Sep. 13, 2012
(86) PCT No.: PCT/KR2012/007340

§ 371 Date: Mar. 26, 2014

(30) Foreign Application Priority Data
Sep. 26, 2011 (KR) 10-2011-0097027

(51) Int. Cl. H04L 29/08; H04L 29/06

(52) U.S. Cl. CPC H04L 67/104; H04L 65/1069
USPC 709/206

(57) ABSTRACT

A peer-to-peer (P2P) message transmission/reception system, a P2P message transmission/reception system and a media key distributing method using the system are disclosed. The P2P message transmission/reception system includes a transmitting client configured to add a first media key issued from a reception-side relay server to media data to be transmitted to the reception-side relay server, the reception-side relay server configured to issue the first media key to the transmitting client, receive the media data from the transmitting client, replace the first media key added to the received media data with a second media key issued from a receiving client, and transmit the media data having the second media key to the receiving client, and the receiving client configured to issue the second media to the reception-side relay server and receive the media data from the reception-side relay server.

### TECHNICAL FIELD

The present disclosure relates to technology for effectively performing peer-to-peer based message transmission/reception.

### BACKGROUND ART

Peer-to-peer (P2P) represents a technology in which a message is transmitted and received through direct communication between peers (clients) without passing through a server on a network. The P2P technology has been developed to facilitate exchange of individual information on a network. P2P was mainly used for illegal sharing of data in its beginning stages, but is now used to transmit high-volume programs and media, and further to service voice over Internet Protocol (VoIP).

In order for clients to transmit and receive a message in a P2P based data transmission/reception system, a path (channel) for data transmission/reception needs to be generated between clients. However, lately, many clients are within network address translation (NAT), and in order to transmit a message to such clients, an NAT traversal may be additionally needed in many cases. However, if the NAT traversal is performed upon every access of a P2P system that may simultaneously perform accesses with a plurality of clients, the access efficiency is lowered. Accordingly, a client within NAT generates a transmission path with a relay server outside of the NAT, and receives a message through the relay server. That is, when a client sends a message to another client, the client attempts to send the message to the other client, and if the attempt fails, sends the message via a relay server connected to the other client.

A method for NAT traversal between a relay sever and a client is mainly divided into two types. In the first, an NAT traversal and port mapping process is individually performed between a relay sever and a client according to an object and type of data to which a client is connected. However, in this case, the more objects there are to be connected, the more ports are required. Accordingly, in a domestic sharing device having a limited number of port mappings, smooth connection becomes more difficult as the number of access clients increases.

In the second, the NAT traversal and port mapping process is performed between a relay sever and a client only once and all messages are transmitted/received through the same port. This method ensures easy access of a plurality of clients even if the number of connectable ports is limited. However, in order to distinguish each message, additional identification information (a P2P header) needs to be added to each message. In particular, for the VoIP having a great number of small messages, a P2P header added to each message causes the total size of the messages to increase significantly, and thus the transmission efficiency is lowered.

### TECHNICAL PROBLEM

The present disclosure is directed to a peer-to-peer (P2P) based message transmission/reception system using a single channel, capable of minimizing overhead due to message transmission/reception by effectively sharing media keys between clients and relay severs for message transmission/reception, and by transmitting/receiving messages using the media keys.

### TECHNICAL SOLUTION

According to an aspect of the present disclosure, there is provided a method of exchanges media keys between a first client, a second client, a first relay server and a second relay sever, the method including: a first step of the first client generating a first message and transmitting the generated first message to the second client via the second relay server; a second step of the second client generating a second message corresponding to the received first message; a third step of the first relay server receiving the second message from the second client, and acquiring a media key of the first client which is included in the received second message; a fourth step of the first client receiving the second message from the first relay server and acquiring a media key of the second relay server which is included in the received second message; a fifth step of the second relay server receiving a third message from the first client and acquiring a media key of the second client which is included in the received third message; and a sixth step of the second client receiving the third message from the second relay sever, and acquiring a media key of the first relay server which is included in the received third message.

According to another aspect of the present disclosure, there is provided a media key management system including: a first client configured to generate a first message, transmit the generated first message to a second client via a second relay server, receive a second message that is transmitted via a first relay server after being transmitted from the second client, and acquire a media key of the second relay server which is included in the received second message; the first relay server configured to receive the second message, which corresponds to the first message, from the second client, and acquire a media key of the first client which is included in the received second message; the second relay server configured to receive a third message from the first client, and acquire a media key of the second client which is included in the received third message; and the second client configured to receive the third message that is transmitted via the second relay server after being transmitted from the first client, and acquire a media key of the first relay server which is included in the received third message.

According to another aspect of the present disclosure, there is provided with a P2P message transmission/reception system including: a transmitting client configured to add a first media key issued from a reception-side relay server to media data to be transmitted to the reception-side relay server; the reception-side relay server configured to issue the first media key to the transmitting client, receive the media data from the transmitting client, replace the first media key added to the received media data with a second media key issued from a receiving client, and transmit the media data having the second media key to the receiving client; and the receiving client configured to issue the second media to the reception-side relay server and receive the media data from the reception-side relay server.

According to another aspect of the present disclosure, there is provided with P2P message transmission/reception including: a transmitting client adding a first media key issued from a reception-side relay server to media data to be transmitted to the reception-side relay server; the reception-side relay server receiving the media data from the transmitting client, replacing the first media key added to the received media data with a second media key issued from a receiving client, and transmitting the media data having the second media key to the receiving client; and the receiving client receiving the media data from the reception-side relay server.

### ADVANTAGEOUS EFFECTS

As is apparent from the above, the P2P transmission/reception system according to the exemplary embodiment of the present disclosure can minimize the overhead due to a P2P header in transmitting media data, such as voice/image, thereby effectively saving the network bandwidth for data transmission/reception, and also enabling smooth communication in a low band environment.

### BRIEF DESCRIPTION OF DRAWINGS

FIG. 1 is a block diagram illustrating a P2P message transmission/reception system according to an exemplary embodiment of the present disclosure;

FIG. 2 is a flowchart showing a method of distributing media keys in a message transmission/reception system according to an exemplary embodiment of the present disclosure;

FIG. 3 is a flowchart showing a process of deleting media keys that are distributed through the process of FIG. 2; and

FIG. 4 is a flowchart showing a process of transmitting/receiving media data between clients after the media key distribution is completed according to the process of FIG. 2.

### DESCRIPTION OF REFERENCE NUMBERS

100: Peer-to-peer message transmission/reception system
102: first client
104: second client
106: first relay server
108: second relay server

### MODE FOR INVENTION

Exemplary embodiments of the present disclosure will be described in detail below with reference to the accompanying drawings. While the present disclosure is shown and described in connection with exemplary embodiments thereof, it will be apparent to those skilled in the art that various modifications can be made without departing from the spirit and scope of the present disclosure.

Description of techniques, which have been widely known in the related technical field and not directly related with the present disclosure, are omitted to make essential points of the present disclosure clear by omitting unnecessary description. Although terms to designate components in this specification are selected from generally and widely used terms in consideration of the function of the component in the present disclosure, the meanings of the terms may be changed to convey the intention of those skilled in the art to which the present disclosure pertains or the customary meaning or adapt to the advent of new technology. Accordingly, it will be understood that terms used in this specification should be construed based on the substantial meaning of the term and the overall context in the specification, instead of being construed only as a name of the component.

Although the preferred embodiments of the present disclosure have been disclosed for illustrative purposes, those skilled in the art will appreciate that various modifications, additions and substitutions are possible, without departing from the scope and spirit of the present disclosure as disclosed in the accompanying claims.

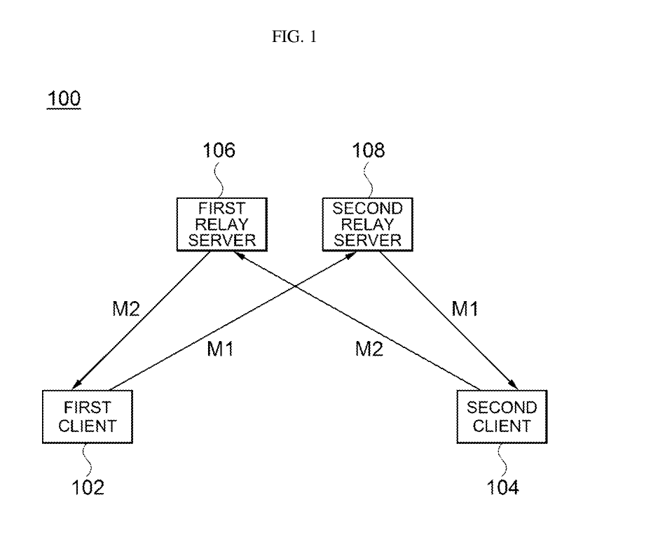

FIG. 1 is a block diagram illustrating a peer-to-peer (P2P) message transmission/reception system 100 according to an exemplary embodiment of the present disclosure. Referring to FIG. 1, the message transmission/reception system 100 according to an exemplary embodiment of the present disclosure includes a first client 102, a second client 104, a first relay server 106 and a second relay server 108.

The first client 102 and the second client 104 each represent apparatuses configured to transmit and receive a message in the message transmission/reception system 100. That is, a message M1 transmitted by the first client 102 is delivered to the second client 104, and a message M2 transmitted by the second client 104 is delivered to the first client 102. The first client 102 and the second client 104 may each be, for example, a VoIP terminal that exchanges a voice message through a VoIP service, and may also be implemented as various types of terminals as long as it can transmit a message in a P2P method.

The first relay server 106 and the second relay server 108 each represent a server configured to relay message transmission/reception between the first client 102 and the second client 104. For example, when the first client 102 or the second client 104 is provided inside a respective network address translation (NAT), a message transmitted by the first client 102 is blocked by the NAT and not delivered to the second client 104, and a message transmitted by the second client 104 is not delivered to the first client 102 either unless an additional NAT traversal process is performed. In this regard, the message transmission/reception system 100 according to this exemplary embodiment of the present disclosure includes the first relay server 106 and the second relay serer 108 outside the NAT, so that the first client 102 and the second client 104 transmit and receive messages without having to perform an NAT traversal process. First, the first relay server 106 performs an NAT traversal and port mapping process with respect to the first client 102 in advance to establish a message transmission path between the first relay server 106 and the first client 102. Similarly, the second relay server 108 performs an NAT traversal and port mapping process with respect to the second client 104 in advance to establish a message transmission path between the second relay server 108 and the second client 104. Thereafter, when the first client 102 transmits a message to the second client 104, the first client 102 does not directly transmit the message by use of a network address (IP/port) of the second client 104, but transmits the message to the second relay server 108 connected to the second client 104, and the second relay server 108 delivers the message, which is received from the first client 102, to the second client 104 through the established transmission path. Similarly, when the second client 104 transmits a message to the first client 102, the second client 104 transmits the message to the first relay server 106 connected to the first client 102, and the first relay server 106 delivers the message, which is received from the second client 104, to the first client 102 through the established transmission path.

In general, only a single transmission path is set between a client and a relay server in consideration of the limited number of port mappings in a sharing device. Accordingly, messages transmitted/received through the transmission path are each configured to include a P2P header so that each message can be easily identified. The P2P header includes the information shown below.
Sender information: a network address of a sender (IP, port) and/or an identification number of a user
Recipient information: a network address of a recipient, and/or an identification number of a user
Information of a reception-side relay server: a network address of a reception-side relay server
Channel information: a unique value to identify a message between a transmitter and a receiver

When messages to be transmitted to the opposite side client have a large size and are small in number, a header including the above information added to each message does not exert a great influence on the total size of the message. However, in a VoIP voice call handling a large number of messages each having a small size, overhead of messages increases due to the headers added. According to the present disclosure, in a step of generating a communication channel for transmitting a message between clients, an authenticated media key is exchanged between a client and a relay server, and from the following transmission/reception of message, a message header only includes the previously exchanged media key, thereby minimizing overhead of messages. According to the present disclosure, a media key refers to a predetermined string of characters used to distinguish a P2P message from other messages between two clients attempting to exchange a P2P message and a relay server attempting to deliver a message to the clients.

For example, according to an exemplary embodiment of the present disclosure shown in FIG. 1, the first client 102, the second client 104, the first relay server 106 and the second relay server 108 issue media keys K1, K2, K3 and K4, respectively, and exchange the media keys K1, K2, K3 and K4 with one another to exchange a message between the first client 102 and the second client 104. Thereafter, when the first client 102 transmits a message to the second client 104, the first client 102 adds the media key K4 of the second relay server 108 to a header of the message to be transmitted to the second relay server 108. The second relay server 108 having received the message recognizes the media key K4 of the second relay server 108 which is added to the received message, thereby learning that the message is transmitted from the first client 102 and needs to be transmitted to the second client 104. Accordingly, the second relay server 108 replaces the media key K4 with the media key K2 of the second client 104 that is a recipient of the message, and transmits the message to the second client 104. On the other hand, when a message is transmitted from the second client 104 to the first client 102, the second client 104 adds the media key K3 of the first relay server 106 to a header of the message to be transmitted to the first relay server 106, and the first relay server 106 replaces the media key K3 of the first relay server 106 with the media key K1 of the first client 102, and transmits the message to the first client 102. That is, the clients and the relay servers transmitting and receiving messages in accordance with the present disclosure may recognize information that is contained in a general P2P header, for example, a sender and recipient of the message and channel information, using only a media key included in a message header.

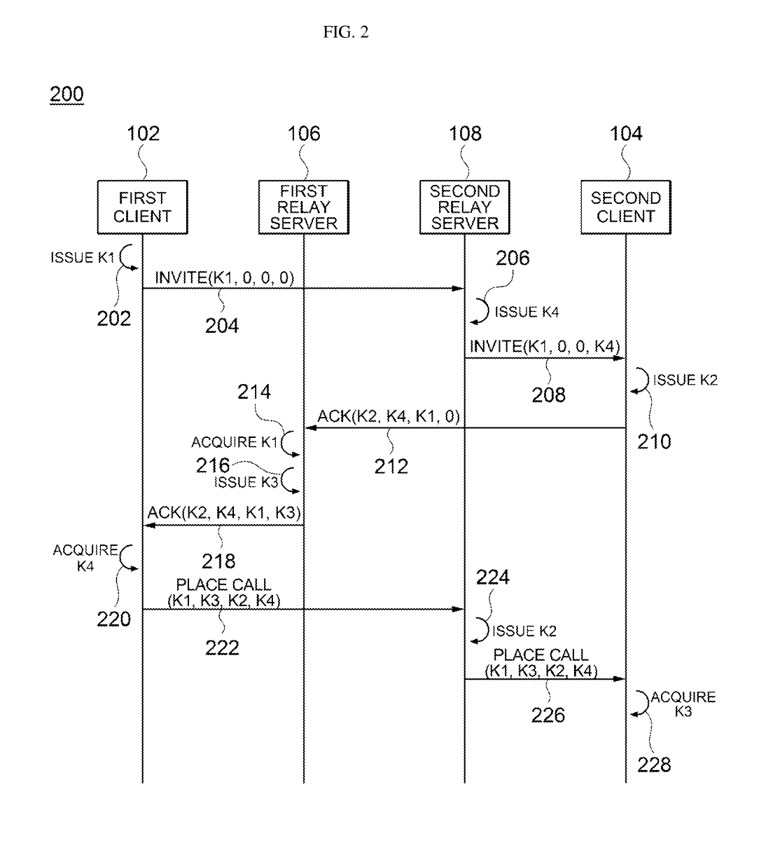

FIG. 2 is a flowchart showing a method 200 of distributing media keys in a message transmission/reception system according to an exemplary embodiment of the present disclosure.

Referring to FIG. 2, the first client 102, the second client 104, the first relay server 106 and the second relay server 108 issue the first media key K1, the second media key K2, the third media key K3 and the fourth media key K4, respectively. In addition, for message transmission/reception, the first client 102, the second client 104, the first relay server 106 and the second relay server 108 need to acquire K4, K3, K1 and K2, respectively.

A process of delivering media keys is accomplished through a process of transmitting channel establishment messages (an INVITE message and an ACK message) for P2P communication and a media data transmission message (a

PlaceCall message). In order to exchange a media key, a header added to the channel establishment message and the media data transmission message further includes an extension field in addition to a general P2P header structure to exchange a media key. The extension field consists of 9 bytes, and has the structure shown below.
MediaKeyCmd (1 byte): a field storing a command for media key generation/discard. The field is used for media key management in a relay server. That is, a relay server issues a new media key if “A” is set in the field, and deletes the previously issued media key if “D” is set in the field. Such an additional field is provided so that a client that explicitly generates a channel for communication with another client is able to synchronize the period of media key generation/discard with the period of channel establishment/discard while a relay server only serves to relay a message received from a client and thus is unable to recognize generation/discard of a channel and has difficulty managing a lifecycle of a media key.
SenderMediaKeyNo (2 bytes): a field storing a media key issued by a client that transmits a message
SenderRelayMediaKeyNo (2 bytes): a field storing a media key issued by a relay server connected to a client that transmits a message
ReceiverMediaKeyNo (2 bytes): a field storing a media key issued by a client that receives a message
ReceiverRelayMediaKeyNo (2 bytes): a field storing a media key issued by a relay server connected to a client that receives a message

In the following description and drawings, an expression (K1, 0, 0, K4) represents a state in which a media key K1 of a transmitting client and a media key K4 of a reception side relay server are issued and stored in the extension field. 0 indicates that no corresponding media key has been issued yet.

Hereinafter, a process of issuing and exchanging media keys among respective components will be described with reference to FIG. 2.

First, the first client 102 issues a media key K1 of the first client 102 (202), and transmits a channel establishment message INVITE including the media key K1 to the second relay server 108 (204). In this case, in an extension field of the channel establishment message INVITE, only K1 is contained, and the remaining field is filled in with 0, yielding (K1, 0, 0, 0).

The second relay server 108 having received the channel establishment message INVITE issues a media key K4 of the second relay server 108 (206), adds the media key K4 to the extension field, and transmits the channel establishment message INVITE (K1, 0, 0, K4) to the second client 104 (208).

Thereafter, the second client 104 having received the channel establishment message INVITE issues a media key K2 of the second client 104 (210), and adds the received K1 and K4 and the issued K2 to an extension field of a header of a channel establishment reply message ACK corresponding to the channel establishment message INVITE, and transmits the channel establishment reply message ACK to the first relay server 106 (212).

The first relay server 106 acquires the first media key K1 of the first client 102 from the received channel establishment reply message ACK received from the second client 104 (214). In this case, the first relay server 106 acquires a network address of the first client 102 together with K1 from the header of the channel establishment reply message ACK, and maps the address to K1. The address needs to be mapped to K1 so that the header of media data only contains the distributed media key after the key media distribution process is completed and does not contain a network address of a receiving client. That is, the first relay server 106 receives a message from the second client 104, and transmits the message to the first client 102 by use of the network address of the first client 102 mapped to K1.

Thereafter, the first relay server 106 issues a media key K3 of the first relay server 106 (216), adds the media key K3 to the channel establishment reply message ACK, and transmits the channel establishment reply message ACK (K2, K4, K1, K3) to the first client 102 (218).

The first client 102 receives the channel establishment reply message ACK and acquires the media key K4 of the second relay server 108 from the channel establishment reply message ACK (220), and generates a media data transmission message PlaceCall (K1, K3, K2, K4) containing the media keys K1, K3, K2, and K4 of the first client 102, the first relay server 106, the second client 104 and the second relay server 108, respectively, and transmits the media data transmission message PlaceCall (K1, K3, K2, K4) to the second relay server 108 (222).

The second relay server 108 acquires the media key K2 of the second client 104 from the received media data transmission message (224). In this case, similar to the first relay server 106, the second relay server 108 acquires a network address of the second client 104 from the media transmission message, and saves the address with K2 mapped.

Thereafter, the second relay server 108 transmits the received media data transmission message PlaceCall to the second client 104 (226).

Finally, the second client 104 acquires the media key K3 of the first relay server 106 from the received media data transmission message, thereby completing the media key distribution process (228).

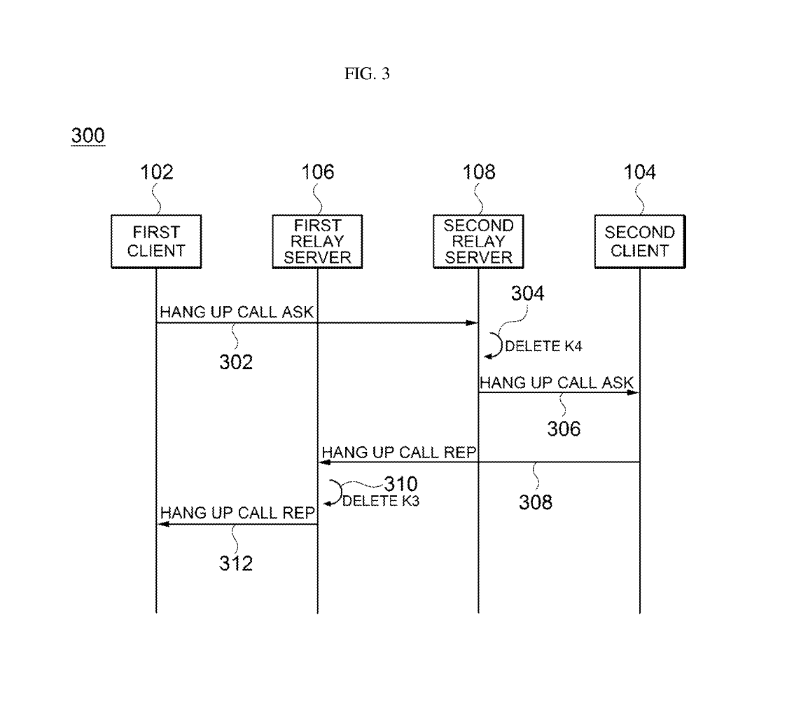

FIG. 3 is a flowchart 300 showing a process of deleting media keys that are distributed through the process of FIG. 2. As described above, the first client 102 and the second client 104 generate media keys when a channel for message transmission/reception is generated, and delete the media keys when the channel is discarded, and therefore a key deletion command is not required for the first client 102 and the second client 104. However, the first relay server 106 and the second relay server 108, which only serve to relay the message received from the first client 102 or the second client 104, do not recognize when a channel is generated and discarded, and thus the first relay server 106 and the second relay server 108 need to delete the media keys through an additional process.

In order to delete a media key of a relay server, media data transmission stop messages HangUpCallAsk and HangUpCallRep are used. The message HangUpCallAsk and HangUpCallRep have a header that is provided in the same form as a message used for media key distribution except for setting a media key deletion command “D” in the first field MediaKeyCmd of an extension field.

Hereinafter, a process of deleting a media key will be described in detail.

First, the first client 102 transmits a media data transmission stop message HangUpCallAsk to the second relay server 108 (302), and the second relay server 108 deletes the media key K4 that is issued by the second relay server 108 (304), and transmits the received media data transmission stop message HangUpCallAsk to the second client 104 (306).

Thereafter, the second client 104 transmits a media data transmission stop reply message HangUpCallRep corresponding to the received media data transmission stop message HangUpCallAsk to the first relay server 106 (308). The first relay server 106, according to the received media data transmission stop reply message HangUpCallRep, deletes the media key K3 that is issued by the first relay server 106 (310), and transmits the received media data transmission stop reply message HangUpCallRep to the first client 102 (312), thereby completing the media key deletion process.

Meanwhile, although the above described media key deletion process of the first relay server 106 and the second relay server 108 have been illustrated as being explicitly performed, the media key may be configured to be deleted when a relay server does not receive a new message from a client for a predetermined period of time. For example, the relay server may additionally manage flags for checking the reception of a message that are mapped to the media keys. In this case, the relay server initializes flags of all media keys to ‘false’ at a predetermined time period using a designated timer, sets a flag of a media key having received media data to ‘true,’ and deletes media keys that remain ‘false’ after the predetermined time period, thereby managing a lifecycle of the media key. Since the media key is periodically managed, the media key of the relay server is prevented from being maintained even after the data transmission/reception abnormally stops, without having to explicitly transmit and receive a data transmission stop message with clients.

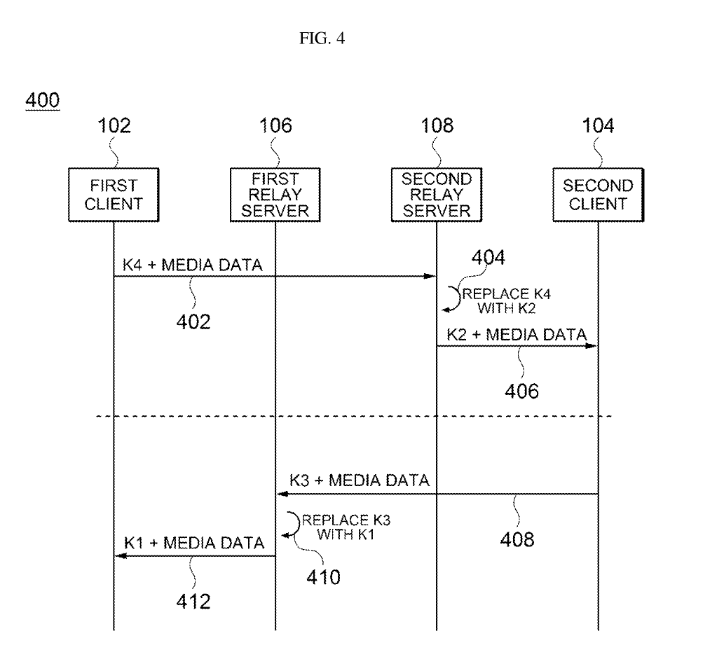

FIG. 4 is a flowchart showing a process of transmitting/receiving media data between clients after the media key distribution is completed according to the process of FIG. 2. Operations 402 to 406 represent a process of transmitting media data from the first client 102 to the second client 104, and operations 408 to 412 represent a process of transmitting media data from the second client 104 to the first client 102.

As described above, after media keys are distributed, each piece of media data is transmitted including a simple header containing the media keys. The header consists of 4 bytes, and has the following structure.
Prefix (1 byte): a field having a fixed value of “M” and used to identify that a certain message is media data
Media Key (2 bytes): a field containing a media key value issued by a reception side that has received the message. For example, when the first client 102 transmits media data to the second relay server 108, the field Media Key contains K4 that is issued by the second relay server 108.
Media Type (1 byte): a field containing a channel value of a session generated between a transmitting client and a receiving client that exchange the message.

According to the present disclosure, when media data is transmitted, a complicated field containing a network address of a transmitting client or a receiving client need not be included in a message and only a downsized header of 4 bytes is added to the message to be transmitted, thereby remarkably reducing data transmission overhead in a P2P data transmission/reception system in which small-sized data is frequently transmitted and received.

In using the above header structure, a process of transmitting media data from the first client 102 to the second client 104 is as follows. First, the first client 102 adds the media key K4 of the second relay server 108 to a header of media data to be transmitted, and transmits the media data to the second relay server 108 (402). Thereafter, the second relay server 108 replaces the media key K4 of the second relay server 108 included in the received media data with the media key K2 of the second client 104 (404), and using the network address of the second client 104 that is mapped to K2, transmits the media data to the second client 104 (406).

A process of transmitting media data from the second client 104 to the first client 102 is as follows. The second client 104 adds the media key K3 of the first relay server 106 to a header of media data to be transmitted, and transmits the media data to the first relay server 106 (408). Thereafter, the first relay server 106 replaces the media key K3 of the first relay server 106 included in the received media data with the media key K1 of the first client 102 (410), and transmits the media data to the first client 102 using the network address of the first client 102 that is mapped to K1 (412).

Meanwhile, the media keys issued and distributed by the first client 102, the second client 104, the first relay server 106 and the second relay server 108 are used only inside the clients and relay servers that are related to message transmission, and need not be unique throughout the entire system, but need only be locally unique within the individual client or relay server. Accordingly, according to the present disclosure, there is no need to perform communication with a key issuing server to verify that a key is unique in a process of issuing each media key. Accordingly, keys are issued and deleted in a rapid manner and need not be managed in a central server.

According to the exemplary embodiment of the present disclosure, all messages are illustrated as passing through the relay servers. However, according to another exemplary embodiment of the present disclosure, messages pass through relay servers only to perform hole punching in a channel establishment process, and an actual message is directly transmitted to an opposite client without passing through the relay servers. To this end, when clients transmit messages for channel establishment, for example, messages INVITE and ACK, the messages are sent by filling media key fields for relay servers with media keys issued by the clients rather than leaving the extension fields empty, thereby preventing the relay servers from issuing media keys. For example, if the first client 102 transmits a message INVITE while setting an extension field to (K1, K1, 0, K1) in operation 204, the second relay server 108 recognizes (K1, K1, 0, K1), and does not issue K4. Similarly, if the second client 104 transmits a message ACK while setting an extension field to (K2, K2, K1, K2) in operation 212, the first relay server 106 recognizes (K2, K2, K1, K2), and does not issue K3.

The program instruction recorded in the computer readable medium may be specially designed for the present disclosure or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical discs, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

1. A method of exchanging media keys between a first client, a second client, a first relay server and a second relay sever, the method comprising:
a first step of generating, by the first client, a first message and transmitting the generated first message to the second client via the second relay server;
a second step of generating, by the second client, a second message corresponding to the received first message;
a third step of receiving, by the first relay server, the second message from the second client, and acquiring a media key of the first client which is included in the received second message;
a fourth step of receiving, by the first client, the second message from the first relay server and acquiring a media key of the second relay server which is included in the received second message;
a fifth step of receiving, by the second relay server, a third message from the first client and acquiring a media key of the second client which is included in the received third message; and
a sixth step of receiving, by the second client, the third message from the second relay sever, and acquiring a media key of the first relay server which is included in the received third message.

2. The method of clam 1, wherein the first message is a channel establishment message (INVITE), the second message is a channel establishment reply message (ACK) corresponding to the channel establishment message, and the third message is a media data transmission message (PlaceCall).

3. The method of claim 2, wherein the first step further comprises:
generating, by the first client, a media key of the first client, and transmitting a channel establishment message including the generated media key of the first client to the second relay server; and
generating, by the second relay server, a media key of the second relay server, adding the media key of the second relay sever to the channel establishment message received from the first client, and transmitting the channel establishment message to the second client;
wherein the third step further comprises:
receiving, by the second client, the channel establishment message from the second relay sever;
generating, by the second client, a media key of the second client, and transmitting a channel establishment reply message including the media key of the first client, the media key of the second relay server and the media key of the second client to the first relay server; and
acquiring, by the first relay sever, the media key of the first client from the channel establishment reply message received from the second client,
wherein the fourth step further comprises:
generating, by the first relay sever, a media key of the first relay sever, and adding the generated media key of the first relay server to the channel establishment reply message received from the second client, and transmitting the channel establishment reply message to the first client; and
acquiring, by the first client, the media key of the second relay server from the channel establishment reply message received from the first relay server;
wherein the fifth step further comprises:
generating, by the first client, a media data transmission message including the media key of the first client, the media key of the first relay server, the media key of the second client and the media key of the second relay server, and transmitting the generated media data transmission message to the second relay server; and
acquiring, by the second relay server, the media key of the second client from the received media data transmission message, and
wherein the sixth step further comprises:
transmitting, by the second relay server, the received media data transmission message to the second client; and
acquiring, by the second client, the media key of the first relay server from the received media data transmission message.

4. The method of claim 3, wherein the acquiring of the media key of the first client by the first relay server further comprises:
acquiring, by the first relay server, a network address of the first client from the received channel establishment reply message; and
storing, by the first relay sever, the acquired network address of the first client associated to the media key of the first.

5. The method of claim 3, wherein the acquiring of the media key of the second client by the second relay server further comprises:
acquiring, by the second relay server, a network address of the second client from the received media data transmission message; and
storing, by the second relay sever, the acquired network address of the second client associated to the media key of the second client.

6. The method of claim 2, further comprising, posterior to the sixth step:
transmitting, by the first client, a media data transmission stop message to the second relay server;
deleting, by the second relay server, the media key of the second relay server according to the received media data transmission stop message, and transmitting the received media data transmission stop message to the second client;
transmitting, by the second client, a media data transmission stop reply message corresponding to the received media data transmission stop message to the first relay server; and
deleting, by the first relay server, the media key of the first relay server according to the received media data transmission stop reply message, and transmitting the received media data transmission stop reply message to the first client.

7. A media key management system comprising:
a first client configured to generate a first message, transmit the generated first message to a second client via a second relay server, receive a second message transmitted via a first relay server after being transmitted from the second client, and acquire a media key of the second relay server which is included in the received second message;
the first relay server configured to receive the second message corresponding to the first message from the second client, and acquire a media key of the first client which is included in the received second message;
the second relay server configured to receive a third message from the first client, and acquire a media key of the second client included in the received third message; and
the second client configured to receive the third message that is transmitted via the second relay server after being transmitted from the first client, and acquire a media key of the first relay server which is included in the received third message.

8. The system of claim 7, wherein the first message is a channel establishment message (INVITE), the second message is a channel establishment reply message (ACK) corresponding to the channel establishment message, and the third message is a media data transmission message (PlaceCall).

9. The system of claim 8, wherein:
the first client generates a media key of the first client, and transmits a channel establishment message including the generated media key of the first client to the second relay server; and
the second relay server generates a media key of the second relay server, adds the media key of the second relay sever to the channel establishment message received from the first client, and transmits the channel establishment message to the second client.

10. The system of claim 9, wherein:
the second client receives the channel establishment message from the second relay sever, generates a media key of the second client, and transmits a channel establishment reply message including the media key of the first client, the media key of the second relay server and the media key of the second client to the first relay server; and
the first relay sever acquires the media key of the first client from the channel establishment reply message received from the second client.

11. The system of claim 10, wherein:
the first relay server acquires a network address of the first client from the channel establishment reply message received from the second client, stores the acquired network address of the first client associated to the media key of the first client.

12. The system of claim 10, wherein:
the first relay sever generates a media key of the first relay sever, and adds the generated media key of the first relay server to the channel establishment reply message received from the second client, to be transmitted to the first client; and
the first client acquires the media key of the second relay server from the channel establishment reply message received from the first relay server.

13. The system of claim 12, wherein:
the first client generates a media data transmission message including the media key of the first client, the media key of the first relay server, the media key of the second client and the media key of the second relay server, and transmits the generated media data transmission message to the second relay server; and
the second relay server acquires the media key of the second client from the received media data transmission message.

14. The system of claim 13, wherein
the second relay server acquires a network address of the second client from the received media data transmission message, stores the acquired network address of the second client associated to the media key of the second client.

15. The system of claim 13, wherein:
the second relay server transmits the received media data transmission message to the second client; and
the second client acquires the media key of the first relay server from the received media data transmission message.

16. The system of claim 8, wherein:
the first client transmits a media data transmission stop message to the second relay server;
the second relay server deletes the media key of the second relay server according to the received media data transmission stop message, and transmits the received media data transmission stop message to the second client;
the second client transmits a media data transmission stop reply message corresponding to the received media data transmission stop message to the first relay server; and
the first relay server deletes the media key of the first relay server according to the received media data transmission stop reply message, and transmits the received media data transmission stop reply message to the first client.

17. A peer-to-peer (P2P) message transmission/reception system comprising:
a transmitting client configured to add a first media key issued from a reception-side relay server to media data to be transmitted to the reception-side relay server;
the reception-side relay server configured to issue the first media key to the transmitting client, receive the media data from the transmitting client, replace the first media key added to the received media data with a second media key issued from a receiving client, and transmit the media data including the second media key to the receiving client; and
the receiving client configured to issue the second media to the reception-side relay server and receive the media data from the reception-side relay server.

18. The system of claim 17, wherein the reception-side relay server stores and manages a network address of the receiving client corresponding to the second media key, and transmits the media data to the receiving client using the network address of the receiving client.

19. The system of claim 17, wherein, when a media key deletion message is received from the transmitting client, the reception side relay server deletes the first media key, and transmits the received media key deletion message to the receiving client.

20. The system of claim 17, wherein, when new media data is not received from the transmitting client for a predetermined time period, the reception side relay server deletes the first media key.

21. A peer-to-peer (P2P) message transmission/reception method comprising:
adding, by a transmitting client, a first media key issued from a reception-side relay server to media data to be transmitted to the reception-side relay server;
receiving, by the reception-side relay server, the media data from the transmitting client, replacing the first media key added to the received media data with a second media key issued from a receiving client, and transmitting the media data including the second media key to the receiving client; and
receiving, by the receiving client, the media data from the reception-side relay server.

22. The method of claim 21, wherein the reception-side relay server transmits the media data to the receiving client using a network address of the receiving client which is stored in correspondence with the second media key.

23. The method of claim 21, further comprising, posterior to the receiving of the media data:
transmitting, by the transmitting client, a media key deletion message to the reception-side relay server;
deleting, by the reception-side relay server, the previously stored first media key according to the received media key deletion message; and
transmitting, by the reception-side relay server, the received media key deletion message to the receiving client.

24. The method of claim 21, further comprising, after the receiving of the media data:
deleting, by the reception-side relay server, the first media key if new media data is not received from the transmitting client for a predetermined time period.

25. A computer-readable storage medium configured to execute the method according to any one of claims 1 to 6 or claims 21 to 24.
